(19) United States
(12) Patent Application Publication
(10) Pub. No.: US 2018/0221907 A1
(43) Pub. Date: Aug. 9, 2018

(54) OIL APPLICATOR FOR CLING FILMS

(71) Applicant: Mahshid Alaghband, London (GB)

(72) Inventor: Mahshid Alaghband, London (GB)

(21) Appl. No.: 15/423,697

(22) Filed: Feb. 3, 2017

(51) Int. Cl. B05C 1/08; B65D 85/672; B65D 83/08

(52) U.S. Cl. CPC B05C 1/08; B65D 83/0841; B65D 85/672

(57) ABSTRACT

The present invention discloses an oil container and applicator system to spread oil on cling films. The applicator includes an elongated container to hold oil, an elongated sponge or roller attached to the top of the container, and an attachment means to attach the container to a cling film box. As the film is passed over the sponge or the roller, it is coated with oil. Once the desired amount of film is removed from the box, the film is cut by a cutter on the container.

### FIELD OF THE INVENTION

The present invention relates generally to bread making process lubricated cling films (saran wrap) and, in particular, to a device to help in the process of making bread dough.

### BACKGROUND OF THE INVENTION

Bread has four basic components: flour, salt, yeast, and a liquid. The components are typically added together in a container at the same time to form a mass of dough. The yeast, however, is usually mixed with a small amount of warm water before it is added to the container in order to dissolve the yeast. After the dough is kneaded, it is left to ferment and then molded into a desired shape, such as a loaf. The dough is then “proofed”, that is, allowed to sit for a period of time in order to allow it to rise and take its final shape. Typically, the bread is proofed at a slightly elevated temperature to increase the activity of the yeast. After being proofed, the dough is baked for a period of time to form bread.

The quality of the bread made can be adversely affected by several factors. One important factor is the exposure of dough to air when it is being proofed. At this time, oxidation may takes place, where oxygen in the ambient air leaches out some of the color, flavor, and nutrients in the dough. Therefore, it is important to control the oxidation process. Although, at the industrial level, the ambient conditions are so designed to control the oxidation, such conditions are difficult to control when making breaking at home. It is therefore, recommended to cover the dough during the proof process to prevent air interaction with the dough. The dough is usually covered with a cling film (saran wrap) before storage. However, dough is very sticky and the wrap has to be well lubricated before use. Lubricating a saran wrap is a difficult process. The present invention is provided for this purpose.

In order to apply oil on a cling film, the film is spread on a counter top and oil is poured on it from a bottle, or sprayed from a pressurized spray can. Oil poured from a bottle may not be uniformly spread through the whole surface of the film. Therefore, the film may stick to the dough at places that are not covered with oil. The present invention will resolve this issue by uniformly spreading a thin layer oil through the whole surface of the film.

It is an object of this invention to provide a combination container and applicator for applying a film of oil to a cooking surface to provide a non-stick cooking surface, and for applying the film selectively to a precise area without overcoating or wasteful spraying.

The preset device is designed to allow a user to easily lubricate a cling film (a saran wrap).

### SUMMARY OF THE INVENTION

The present invention is an oil applicator for applying oil on cling films used for covering food products, in particular, for covering bread dough. The applicator assembly comprises of an elongated elements that attaches longitudinally to a box containing cling film (saran wrap). One face of the element comprises of an oil saturated foam, roller, or any material that can hold oil. As the film rolls out of the box, it goes over the oily face of the applicator and becomes coated with oil. Different embodiments of this applicator are disclosed that attach to different parts of the box.

The first objective of the present invention is to provide a device to make it easy to lubricate cling films and saran wraps.

The third objective of the present invention is to provide a system to prevent dough to stick to a cling film.

The forth objective of the present invention is to provide an oil applicator that can be used by any cling film dispensers and cling film boxes.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 illustrates the first embodiment of the present oil applicator;

FIG. 2 illustrates the second embodiment of the present oil applicator, and

FIG. 3 illustrates the third embodiment of the present oil applicator.

The figures are not intended to be exhaustive or to limit the present invention to the precise form disclosed. It should be understood that the invention can be practiced with modification and alteration, and that the disclosed technology be limited only by the claims and equivalents thereof.

### DETAILED DESCRIPTION OF PREFERRED EMBODIMENTS

The device disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

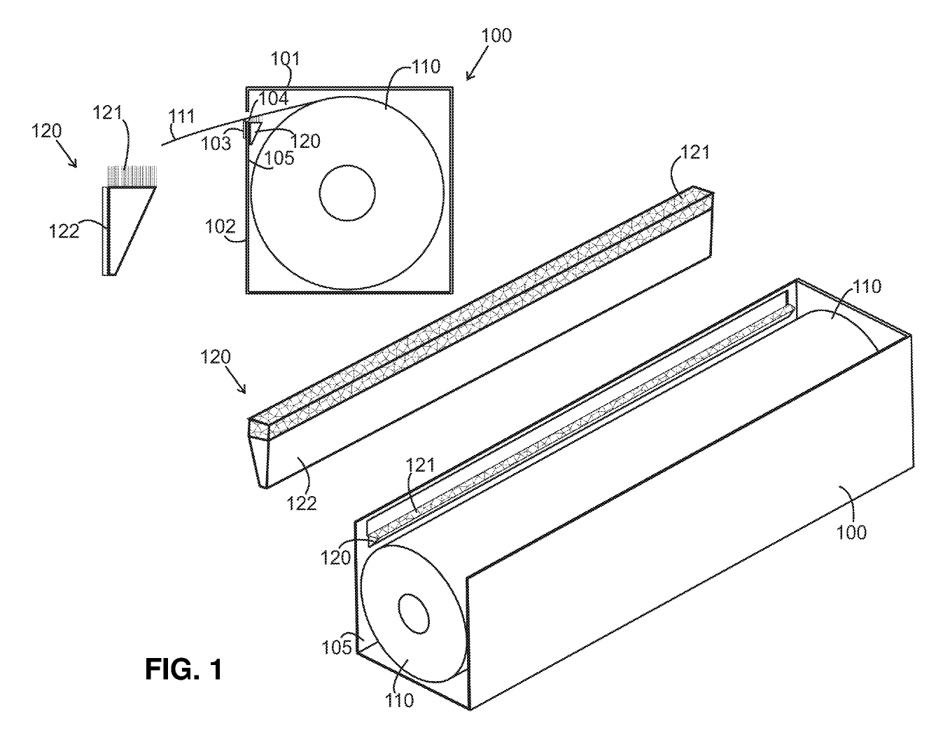

FIG. 1 shows the first embodiment of the present cling film oil applicator. A cling film box 100 is a rectangular box that stores a cling film role 110. The box has a top opening cap 101 that extends over the front face 102 of the box. A cutter 103 is attached to the front face 102 of the box and just below the front rim 104 of the box be to cut the cling film 111 once a desired length is removed from the box. An oil applicator 120 is attached to the inner surface 105 of the front face of the box on the opposite side of where the cutter is attached, and adjacent to the box lid 104.

The applicator 120 comprises of an elongated element having a top surface 121 and a side surface 122. The top surface 121 comprises of a sponge like material, such as plastic or polymer foams, cellulose wood fiber, natural sponge, high-density polyether, or polyester.

The side surface attaches to the inner surface 105 of the box. Any type of attachment can be used to attach the applicator to the box. A preferred attachment means is an adhesive to stick the applicator to the box. Other types of attachments, such as hook and loop attachments, or pins can be used as well.

The length of the applicator is substantially the same as the length of the cling film box and is at least the same width of the cling film. The applicator is attached to the inner surface 105 of the box such that the oil applicator extends above the rim of the box. Thereby, as a cling film is rolled out of the box it slides over the applicator to become coated by oil.

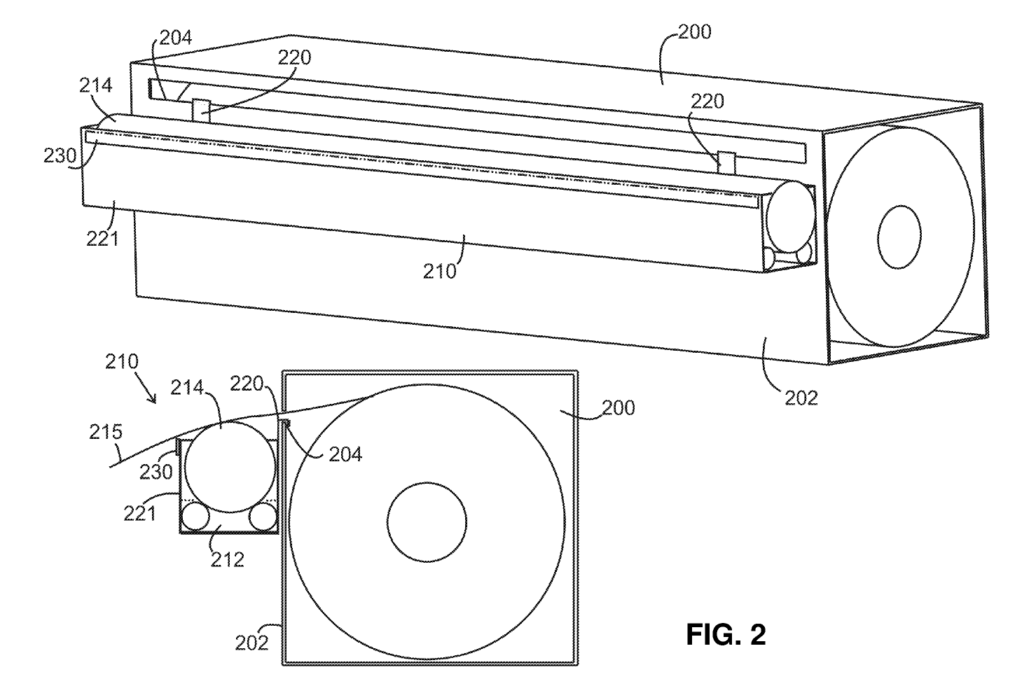

A second embodiment of the same invention is shown in FIG. 2. The applicator 210 in this embodiment is a roller that attaches to the outer surface 202 of the cling film box 200. The roller applicator comprises of an oil container 211, container an oil 212, and a roller 214 that applies oil on the cling film 215, as it rolls over the roller 214. A cutter 220 allows cutting the cling film at a desired length. The cutter 220 is located on the outer surface 221 of the applicator container 211 and extends outwardly to easily cut the cling film by downwardly forcing the film on the cutter.

In the second embodiment, the attachment means is a pair of hooks 220 that hook the applicator 210 on the rim 204 of the box 200. This removable attachment, instead of an adhesive, allows the applicator to be removed when the cling film is not used for applying oil. The removable attaching means can also be a set of clips to clip the element to the edges of the box, or a set of hook and loop attachment means, or any other removable attachment means.

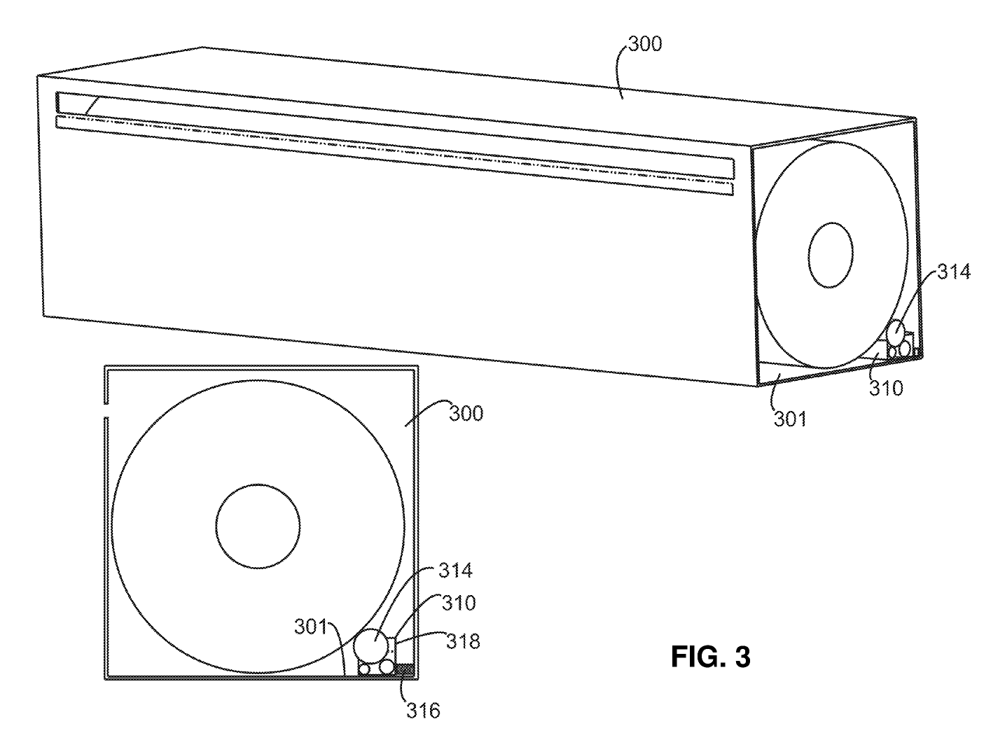

In a third embodiment of the same invention, an applicator 310 is installed inside the cling film box 300, as illustrated in FIG. 3. The oil applicator of this embodiment is a sponge or a roller applicator 314 that is installed on the bottom surface 301 of the sling film box. A small spring 316 is attached to the back 318 side of the applicator container 310 to continuously force the applicator onto the cling film surface 320. As the cling film roll reduces in size, the applicator should be pushed forward and be in contact with the cling film surface.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

1.-5. (canceled)

6. A standalone oil applicator for applying a film of an oil on a cling film of a cling film box, wherein said cling film box is sized to receive and stores a cling film roll, said cling film box having a box-width, a front-side with a front-edge, a lid, a bottom side, and a cutter for cutting said cling film, said cutter secured on said front-side close to the front-edge of the box, said oil applicator comprising:
a. an elongated container having substantially the same width as said cling film box-width, and having a top side, said elongated container attached to the outside face of the front side of said cling film box, said elongated container sized to hold an oil and having a top side;
b. a roller mechanism partially exposed to the top side of said elongated container;
c. an attachment mechanism to attach said elongated container to said cling film box, whereby the sponge or roller applies a thin layer of the oil on the cling film as the film is extended out of the cling film box while passing over said sponge or roller.

7. The oil applicator of claim 6, further having a cutter attached to a front surface of said elongated container.

8. The oil applicator of claim 6, wherein said attachment mechanism to attach said elongated container to said cling film box is an adhesive attachment.

9. The oil applicator of claim 6, wherein said attachment mechanism to attach said elongated container to said cling film box is a set of hooks that removably hook on said front edge of said cling film box.

10. The oil applicator of claim 6, wherein said attachment mechanism to attach said elongated container to said cling film box is a set of hook and loop attachments that removably attach on said front edge of said cling film box.

11.-12. (canceled)
